(19) United States
(12) Patent Application Publication
(10) Pub. No.: US 2006/0047412 A1
(43) Pub. Date: Mar. 2, 2006

(54) Service system and method for addressing problems via a distant third party translation

(76) Inventor: Keh-I Lin, Taichung (TW)

Correspondence Address: Dennison, Schultz & Dougherty & MacDonald;Suite 105, 1727 King Street, Alexandria, VA, 22314, US

(21) Appl. No.: 10/926,990

(22) Filed: Aug. 27, 2004

(51) Int. Cl. G01C 21/36

(52) U.S. Cl. 701/200

(57) ABSTRACT

A service system supplies a 24-hour service to assist a traveler such as a traveler to effectively address everyday problems occurring in places where the local language is incomprehensible to the traveler. The system provides the traveler a mobile communication device rented from a local telecommunications company. When a problem arises for the traveler, the mobile communication device is able to contact with a problem-solving center in which operators with ability of speaking different languages play a role of intermediary between the traveler and local inhabitant to help the traveler solve problems.

### BACKGROUND OF THE INVENTION

1. Field of the Invention

The present invention relates to a service system and a method for addressing problems experienced by travelers, and particularly relates to a service system that assists travelers to address effectively their problems aggravated by the travelers being ignorant of the local language.

2. Description of Related Art

Tourism, especially international tourism, is predicted to rise even faster in the 21^{st} century than the previous century and so the problem of communications among those that speak different languages will inevitably worsen. The use of a language translator, i.e. an electronic dictionary, may be a feasible approach, but it is not efficient to deal with some urgent situations. For example, when doing shopping, requesting traffic information, seeking emergency medical treatment, calling police etc., foreign travelers need to immediately and distinctly describe their situations to local people. However, due to the language barrier, these travelers may experience significant problems in expressing their intentions and requirements if there is no interpreter or local person to help them.

Even though the travelers can acquire assistance from local relatives or friends, it still is a temporary approach after all and not dependable.

### SUMMARY OF THE INVENTION

The main objective of the present invention is to provide a service system and a method to addressing travelers' everyday problems while they are in foreign places.

Other objectives, advantages and novel features of the invention will become more apparent from the following detailed description when taken in conjunction with the accompanying drawings.

### BRIEF DESCRIPTION OF THE DRAWING

FIG. 1 is a block diagram of a service system in accordance with the present invention.

### DETAILED DESCRIPTION OF THE PREFERRED EMBODIMENT

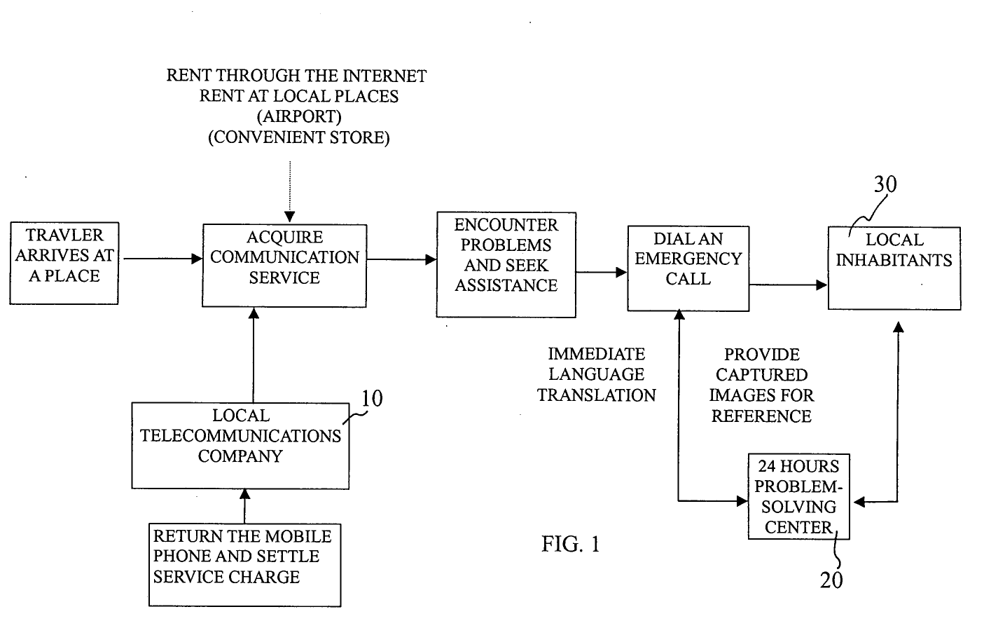

FIG. 1 shows a block diagram of a service system in accordance with the invention. When a traveler arrives at a place and finds the language is incomprehensible, a communication service from a local telecommunications company (10) is firstly acquired. For example, the traveler may rent a local-used mobile phone, a GSM (Global System for Mobile Communications) communication chip or a PHS (Personal Handyphone System) chip compatible for the person's own mobile phone from the local telecommunications company. The person can rent the mobile phone through the Internet in advance so as to immediately acquire the device when arriving at the destination. Alternatively, to transact the renting facility at local service places is practicable. The service places can be set up in the local airport or convenience stores. Moreover, insurance companies, travel agencies, credit card companies, hotels or airline companies also can cooperate with the telecommunications company to supply renting services of mobile phones.

When the traveler encounters any problem in the travel period, a problem-solving center (20) can be telephoned by using the rented mobile phone to seek assistance. An emergency phone number is pre-recorded in the mobile phone allowing the user to directly dial by single touch etc the problem-solving center (20). The emergency phone number may be set to be the same in all countries, such as 888. The problem-solving center (20) employs operators with capability of speaking more than two different languages to provide a 24-hour customer service. When the traveler calls the problem-solving center (20) to receive assistance, the operator can use the traveler's native language to solve the problem(s).

Further, since most mobile phones are already provided with an image capturing function, the traveler can take related pictures and send them to the problem-solving center (20) in order to explain the problem(s) in more detail.

The operator may directly communicate with a local person (30), such as a police officer, a salesclerk or medical personnel around the traveler. In that situation, the operator can speak the local language with the person (30) so as to immediately deal with what problems the traveler is facing. The operator subsequently reports discussion result to the traveler. In short, the operator of the problem-solving center (20) plays a role of communication bridge between the local person (30) and the traveler to transmit the two parties' comments.

When the foreign traveler leaves the local place, the mobile phone is returned to the local telecommunications company. Meanwhile, the service fee including the rental of the mobile phone is settled when the traveler returns the phone to the original service location where the renting process was transacted. Through the foregoing description, the present invention provides a 24-hour service system that can help travelers address their everyday problems that arise in nations speaking a language incomprehensible to the traveler.

It is to be understood, however, that even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. A service method for addressing a traveler's problems occurring in a local place where a language incomprehensible to the traveler is spoken, the method comprising the acts of:
providing the traveler a mobile communication device, wherein the traveler acquires a communication service from a local telecommunications company so that the traveler is able to communicate with any local person by using the mobile communication device;
permitting the traveler to send a help request a problem-solving center by using the mobile communication device; and
the problem-solving center responding to the request, wherein the problem-solving center is able to communicate with the traveler in a first language, and able to communicate with any local person in a second language so as to assist the traveler to effectively address the problems.

2. The method as claimed in claim 1, wherein the mobile communication device is rented from the local telecommunications company.

3. The method as claimed in claim 1, wherein the traveler rents the mobile communication device from a local service place of the local telecommunications company set up in a local airport.

4. The method as claimed in claim 3, wherein the traveler rents the mobile communication device through the Internet in advance so as to immediately acquire the mobile communication device when arriving at the local service place.

5. The method as claimed in claim 1, wherein the problem-solving center employs operators with capability of speaking more than two different languages to provide a 24-hour customer service.

6. The method as claimed in claim 1, wherein the traveler returns the mobile communication device and settles total service charge with the local telecommunications company.

7. A service system for addressing a traveler's problems occurring at an exotic place where the local language is incomprehensible to the traveler, the system comprising:
a local telecommunications company that provides the traveler a local communication service so that the traveler is able to vicariously communicate with any local person by using the mobile communication device, wherein an emergency phone number is pre-recorded in the mobile communication device;
a problem-solving center sited at the local place, responding to a request sent from the traveler, wherein the problem-solving center is able to communicate with the traveler in a first language, and able to communicate with any local person in a second language so as to assist the traveler to address the problems.

8. The system as claimed in claim 7, wherein the traveler rents the mobile communication device from one of a plurality of local service places of the local telecommunications company.

9. The system as claimed in claim 8, wherein the problem-solving center employs operators with a capability of speaking more than two different languages to provide a 24-hour customer service.

10. The system as claimed in claim 9, wherein the one of the plurality of local service places is set up in a local port.

11. The system as claimed in claim 9, wherein the traveler rents the mobile communication device through the Internet in advance so as to immediately acquire the mobile communication device when arriving at the local service place.

12. The system as claimed in claim 10, wherein the mobile communication device is provided with a capability of image capturing and allowing the traveler to take and send pictures to the operators of the problem-solving center.

13. The system as claimed in claim 11, wherein the mobile communication device is provided with a capability of image capturing and allowing the traveler to take and send pictures to the operators of the problem-solving center.

14. The system as claimed in claim 8, wherein the traveler returns the mobile communication device and settles a total service charge with the local telecommunications company.
